(19) United States
(12) Patent Application Publication
(10) Pub. No.: US 2006/0034498 A1
(43) Pub. Date: Feb. 16, 2006

(54) Fingerprint identification data accessing device

(76) Inventors: Shi Shing Chang, Taipei Hsien (CN); Ta Lang Hsu, Taipei Hsien (CN); Yi Ching Shi, Taipei Hsien (TW)

Correspondence Address: Shi Shing Chang, 235 Chung-Ho, Box 8-24, Taipei, TW

(21) Appl. No.: 11/178,794

(22) Filed: Jul. 12, 2005

(30) Foreign Application Priority Data
Aug. 11, 2004 (TW) 093212745

(51) Int. Cl. G06K 9/00

(52) U.S. Cl. 382/124

(57) ABSTRACT

A fingerprint identification data accessing device comprises a fingerprint detector for detecting the fingerprint applied thereon as inputted the fingerprint data; a memory unit; a verification and coding module having a verification unit for verifying the inputted fingerprint data with the predetermined fingerprint data, if the inputted fingerprint data is identical to the predetermined fingerprint data, an authorization is given, if fails, the data accessing device is closed or the user is requested to re-input the fingerprint data; and a coding chip; as the authorization is given, the coding chip will be actuate to allow to access the data stored in the memory unit; otherwise the data in the memory unit cannot be read. The data accessing device is capable of being connected to an external computer for performing mathematical operation required in the verification and receiving input encrypted codes from users.

### FIELD OF THE INVENTION

The present invention relates to fingerprint identification, and particularly to a fingerprint identification data accessing device, wherein the data in the memory unit is encoded. If the fingerprint identification is correct, the data can be read by decoding. Furthermore, not only the fingerprint is used in identification, but also other codes inputted to computers can be used in identification.

### BACKGROUND OF THE INVENTION

In the prior art fingerprint identification data accessing device, the data is read from a memory as an input fingerprint is allowed. However when the memory device is separated from the fingerprint identification data accessing device, the data in the memory device can be read out directly without any function of fingerprint identification.

Moreover, in the prior art fingerprint identification machine, only the fingerprint is used as an only input. This is inconvenient in use. Thereby it is necessary to be improved.

### SUMMARY OF THE INVENTION

Accordingly, the primary object of the present invention is to provide a fingerprint identification data accessing device, wherein the data in the memory unit is encoded. If the fingerprint identification is correct, the data can be read by decoding.

The further object of the present invention is to provide a fingerprint identification data accessing device, wherein not only the fingerprint is used in identification, but also other codes inputted to computers can be used in identification.

To achieve above objects, the present invention provides a fingerprint identification data accessing device which comprises a fingerprint detector for detecting the fingerprint applied thereon as inputted the fingerprint data; a memory unit; a verification and coding module having a verification unit for verifying the inputted fingerprint data with the predetermined fingerprint data, if the inputted fingerprint data is identical to the predetermined fingerprint data, an authorization is given, if fails, the data accessing device is closed or the user is requested to re-input the fingerprint data; and a coding chip; as the authorization is given, the coding chip will be actuate to allow to access the data stored in the memory unit; otherwise the data in the memory unit cannot be read. The data accessing device is capable of being connected to an external computer for performing mathematical operation required in the verification and receiving input encrypted codes from users.

The various objects and advantages of the present invention will be more readily understood from the following detailed description when read in conjunction with the appended drawing.

### BRIEF DESCRIPTION OF THE DRAWINGS

FIG. 1 is a schematic view of the present invention.

FIG. 2 is a block diagram about the system of the present invention.

FIG. 3 shows the flow diagram of the present invention.

### DETAILED DESCRIPTION OF THE INVENTION

In order that those skilled in the art can further understand the present invention, a descripticon will be described in the following in details. However, these descriptions and the appended drawings are only used to cause those skilled in the art to understand the objects, features, and characteristics of the present invention, but not to be used to confine the scope and spirit of the present invention defined in the appended claims.

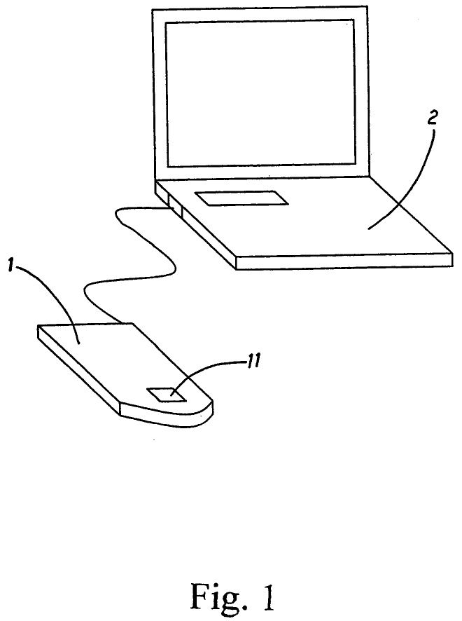

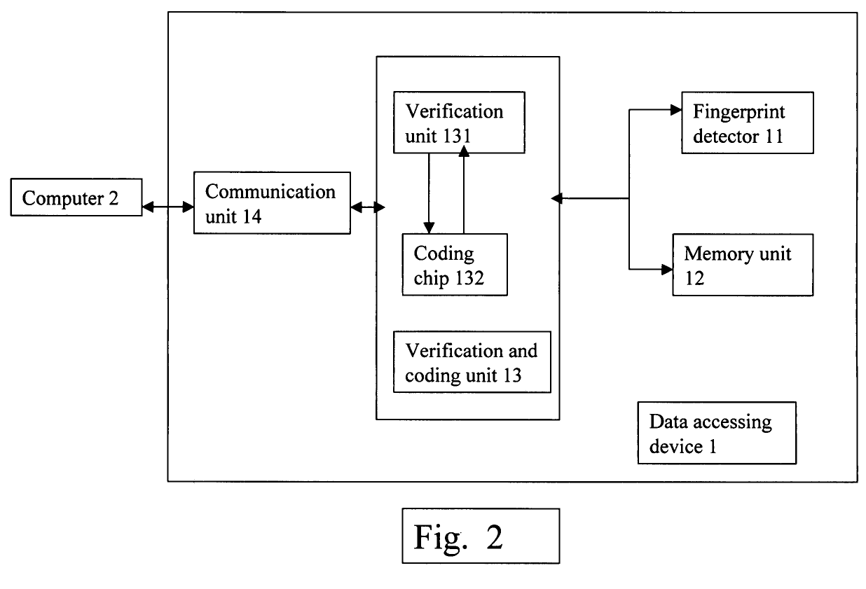

Referring to FIGS. 1 and 2, the present invention has the following elements.

A computer 2 serves to perform the mathematical operation and receives input encrypted codes from user.

A data accessing device 1 is connected to the computer 2 through a USP interface or an IEEE standard (for example, IEEE1394) interface. The data accessing device 1 has the following elements.

A fingerprint detector 11 serves to detect the fingerprint applied thereon as inputted fingerprint data.

A verification and coding module 13 has a verification unit 131 for verifying the inputted fingerprint data with the predetermined fingerprint data. If the inputted fingerprint data is identical to the predetermined fingerprint data, an authorization is given. If fails, the data accessing device 1 is closed or the user is requested to re-input the fingerprint data. The verification and coding module 13 further includes a coding chip 132 for encoding data which is then stored in the memory unit and decoding the data outputted from the memory unit. As the authorization is given, the coding chip 132 will be actuated to allow to access the data stored in the memory unit 12. Otherwise the data in the memory unit 12 can not be read.

Furthermore, in the present invention, the data accessing device is capable of being connected to an external computer for performing mathematical operation required in the verification and receiving input encrypted codes from users. The data accessing device accepts a code inputted from the computer as an auxiliary code in identification.

In the present invention, the memory unit 12 is one of a hard disk, a memory and a memory card.

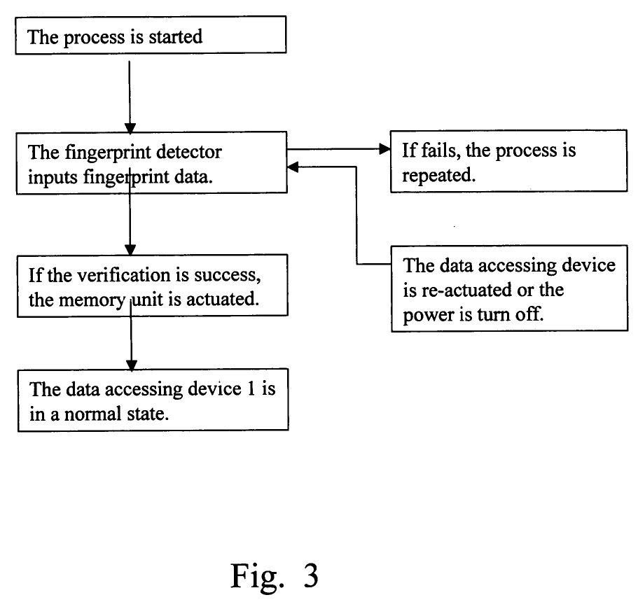

FIG. 3 shows the process of the present invention.

In first step, the process is started.

In the second step, the fingerprint detector 11 inputs fingerprint data.

In the third step, if the verification is success, the memory unit 12 is actuated.

In the fourth step, the data accessing device 1 is in a normal state.

In the fifth step, if fails, the process is repeated.

In the sixth step, the data accessing device 1 is re-actuated or the power is turn off.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A fingerprint identification data accessing device comprising:
a fingerprint detector for detecting the fingerprint applied thereon as inputted the fingerprint data;
a memory unit with encoding data;
a verification and coding module having
a verification unit for verifying the inputted fingerprint data with the predetermined fingerprint data, if the inputted fingerprint data is identical to the predetermined fingerprint data, an authorization is given, if fails, the data accessing device is closed or the user is requested to re-input the fingerprint data; and
a coding chip for encoding data which is then stored in the memory unit and decoding the data outputted from the memory unit; as the authorization is given, the coding chip will be actuated to allow to access the data stored in the memory unit and the encoding data is decoded by the coding chip; otherwise the data in the memory unit cannot be read.

2. The fingerprint identification data accessing device as claimed in claim 1, wherein the memory unit is one of a hard disk, a memory and a memory card.

3. The fingerprint identification data accessing device as claimed in claim 1, wherein the data accessing device connected to the computer through a USP interface or an IEEE standard.

4. The fingerprint identification data accessing device as claimed in claim 1, wherein the data accessing device is capable of being connected to an external computer for performing mathematical operation required in the verification and receiving input encrypted codes from users.

5. The fingerprint identification data accessing device as claimed in claim 1, wherein the data accessing device accepts a code inputted from the computer as an auxiliary code in identification.
